(19) United States
(12) Patent Application Publication
(10) Pub. No.: US 2010/0111292 A1
(43) Pub. Date: May 6, 2010

(54) AGGREGATE AND PARALLELIZABLE HASH FUNCTION

(75) Inventors: Pierre Betouin, Boulogne (FR); Mathieu Ciet, Paris (FR); Augustin J. Farrugia, Cupertino, CA (US)

Correspondence Address: Apple Inc., 1000 Louisiana Street, Fifty-Third Floor, Houston, TX, 77002, US

(73) Assignee: Apple Inc., Cupertino, CA (US)

(21) Appl. No.: 12/263,071

(22) Filed: Oct. 31, 2008

(51) Int. Cl. H04L 9/28

(52) U.S. Cl. 380/28

(57) ABSTRACT

A hash provides aggregation properties, and allows distributed and/or concurrent processing. In an example, the hash operates on message M, and produces a multiplicative matrix sequence by substituting a 2×2 matrix A for binary ones and substituting a 2×2 matrix B for binary zeros in M. A and B are selected from SL₂(R), R=F₂[x]/(P), F₂[x] being the set of polynomials degree with coefficients in F₂={0,1}, and (P) is the ideal of F₂[x] generated by irreducible polynomial P(x) order n=1²/4. The matrix sequence is multiplied to produce a 2×2 matrix, h, with n bit length entries. A function converts h into an l×l matrix, Y. Two l×l invertible matrices with randomly chosen F₂ entries, P and Q, are accessed. P pre-multiplies Y and Q⁻¹ post-multiplies Y to produce a final hash value. M can be subdivided into m₁ . . . mₜ, corresponding h₁ . . . hₜ can be produced, and the Y matrix produced from a product of h₁ . . . hₜ to get the same hash value. Respective P and Q combinations can be unique to and pre-shared with each entity pair, so only those entities can compute valid hash data. Other hash functions and implementations can be provided according to this example.

### FIELD

The following relates to a hash function which provides the aggregation property and for which computation can be parallelized.

### RELATED ART

Hash functions can be used for a variety of purposes in the areas of authentication, encryption, document signing and so on. Properties of hash functions for most such purposes have a baseline common set of desirable characteristics. These characteristics include preimage resistance, meaning that it is difficult to determine a document that can be hashed to a specified hash value. Another characteristic is second preimage resistance, meaning that it is difficult to find a second input that hashes to the same hash value as a specified input. A related characteristic is that different documents should reliably produce different hash values (non-collision).

Another, less common, property of hash functions used in the area of encryption and other related data security fields is aggregation. Most hash functions used in the field of data security require recomputation of the hash of an entire message when further data is appended to the message. Values produced in computing the hash of the original message generally are not reused in computing the hash of the appended message. A hash function that has the property of aggregation, however, can use values produced during computation of a hash value for an original message when computing the hash for the appended message.

Hash functions with these properties remain the subject of ongoing research, and further advancements in this area are useful.

### SUMMARY

The following relates to providing a hash function that can meet principal desired hash properties, including preimage, second preimage, and collision resistance, while also providing other properties that can be desirable in some applications including aggregation (e.g., providing a hash of a file comprising an original dataset and a dataset appended thereto) as well as parallelization. The aggregation property of the hash function can be useful in situations where portions of a given message are streamed over a period of time to a receiving entity, or where a file may be appended frequently, such as a log file.

In a first aspect, a method for hashing a message comprises accessing a first 2×2 matrix A and a second 2×2 matrix B. The matrices A and B are each selected from the Special Linear group SL₂(R). R is a commutative field defined as R=F₂[x]/(P), with F₂[x] being the set of polynomials having coefficients selected from the set of F₂={0,1}, and (P) being the ideal of F₂[x] generated by an irreducible polynomial of order n.

The method further comprises accessing a message M as a sequence of bits. The method also comprises producing a multiplicative matrix sequence by substituting one of the B matrix and the A matrix either for binary 0 bits or for binary 1 bits in M, and substituting the other of the B matrix and the A matrix for the other of binary 0 bits and binary 1 bits. Alternatively expressed, A and B can be selected arbitrarily from suitable matrices, and one of A and B is substituted for binary 0 bits, and the other of A and B is substituted for the binary 1 bits in M.

The method further comprises computing the product of the matrices in the sequence to produce a 2×2 matrix (h). Each element of h has n bits. The method further comprises rearranging the bits of h into an l by l matrix Y, and computing g=PYQ^{—1}. P and Q are each invertible l by l matrices with elements randomly chosen from F₂. The calculated g value, or a value derived therefrom, is outputted as the hash for the message M.

As an example of the aggregation property provided by hash functions according to these disclosures, the method may further comprise producing a second matrix sequence for a message M₂, that is to be concatenated with an M₁, and computing the product of the matrices in the second matrix sequence to produce a 2×2 matrix (h₂). Each element of h₂ has n bits. The method also comprises multiplying an h₁ produced for M₁ and h₂ to produce a 2×2 matrix h₁₂; each element of h₁₂ also has n bits. The method also comprises rearranging the bits of h₁₂ into an l by l matrix Y₁₂ and computing g′=PY₁₂Q⁻¹ as a hash for the concatenation of message M₁ and M₂. This example can be extended to a large number of message portions, such that hash computation can be distributed among a plurality of processing resources.

The bit rearranging step of the method can be performed by an invertible defolder function. The defolder function in some cases receives a 2×2 matrix, with each element having n bits, and outputs the l by l matrix Y having a total of 4n bits. In other cases, the defolder function can compress or expand the number of bits either inputted or outputted.

An entity can recover h from g=PYQ⁻¹ by using an inverse of F, an inverse of P, and Q. Q is invertible and computing its inverse, Q⁻¹, is straightforward. There can be a unique P and Q pair pre-shared between each pair of entities seeking to exchange messages and hashes thereof. An entity seeking to validate a message using a g value calculated therefore can independently calculate a g value based on the data received for the message and compare the g values, or the entity can recover the h value and compare a computed h to the recovered h.

### BRIEF DESCRIPTION OF THE DRAWINGS

FIG. 1 depicts an arrangement comprising a plurality of systems that can exchange messages and hash values that can be used by systems receiving the messages to validate the messages;

FIG. 2 depicts data flow and method steps for a first example method;

FIG. 3 depicts steps of a method for initializing entities, such as transmitting and receiving devices, to perform implementations of the hashing operations described herein;

FIG. 4 depicts steps of a second method including various hashing options, and which can be implemented in a transmitting device;

FIG. 5 depicts steps of a method that can be implemented in a system receiving messages and hash values that can be generated according to the methods of FIGS. 2 and 4, and using the hash values for message validation; and

FIG. 6 depicts components that can form an example system that can be used in the arrangement of FIG. 1.

### DESCRIPTION

The following relates to providing a hash function that can meet principal desired hash properties, including preimage, second preimage, and collision resistance, and which also has the aggregation property (providing a hash of a file comprising an original dataset and a dataset appended thereto with reuse of at least some values computed during the computation of the hash for the original dataset), and/or parallelization (concurrently performing computations of a hash function for a message in multiple processing resources).

Many hash functions well-known in the area of data security and encryption, such as MD5 and SHA-1, operate on blocks of message data. For example, MD5 operates on 512 bit blocks and produces a 128 bit hash value. These hash functions do not provide the aggregation property. Larger data sets, such as audiovisual information (e.g., streaming media, logging functions, and so on), can benefit from a hash having aggregate properties. A Tillich-Zemor hash function operates instead on a bitstream, and aspects concerning this hash function are described in more detail in an example depicted in FIG. 2 and described below.

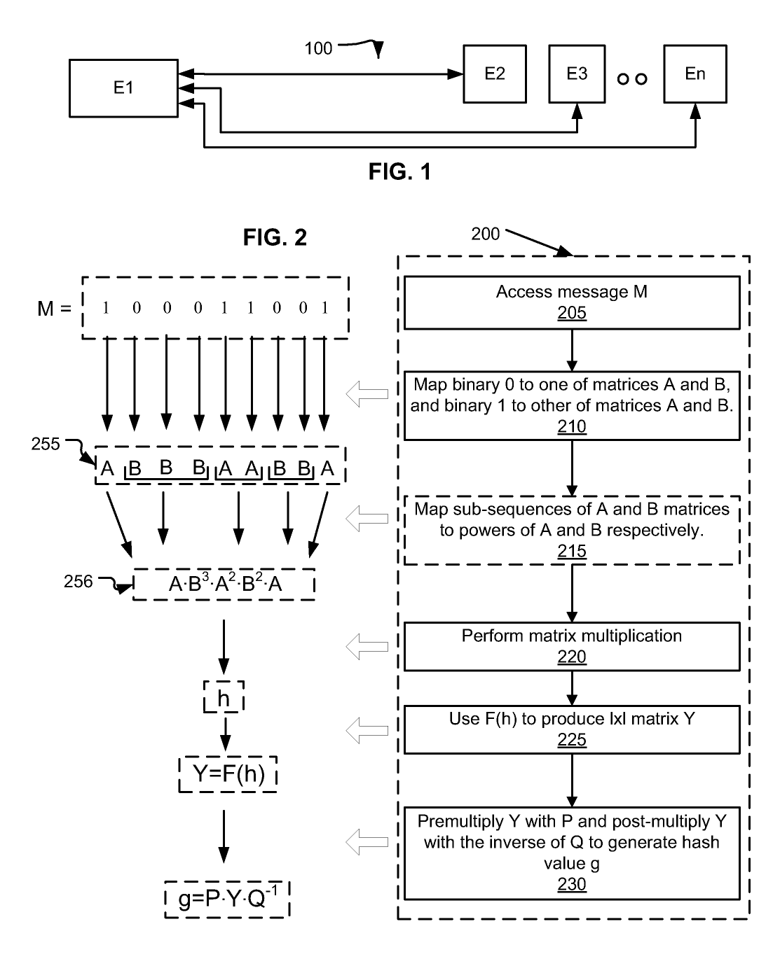

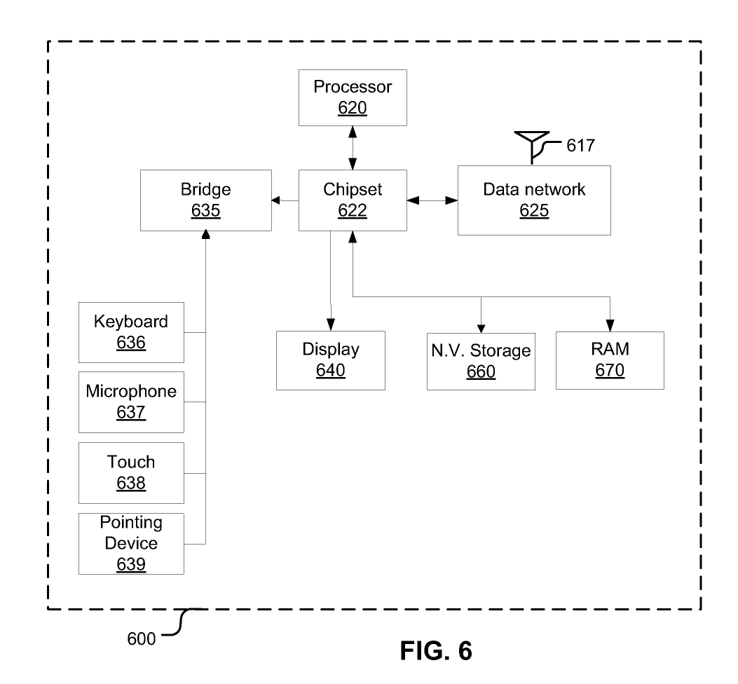

FIG. 1 depicts an example context in which hash functions according to these disclosures can be used. In FIG. 1, an entity E₁ may communicate with a plurality of other entities E₂, E₃, through Eₙ. E₁ can send a message to entities E₂, through Eₙ, and produce a hash for the message according to these disclosures. Each of these entities represents an abstraction for any of a variety of devices, functions, software, and so on. For example, each entity may comprise hardware and/or software implementing a device, such as a computer, a cell phone, a processor, a processor core, a display, and so on. An example of structure comprised in the entities of FIG. 1 is provided in FIG. 6.

In the particular example of FIG. 1, E₁ distributes information (referred to as a message herein) to E₂, through Eₙ, and creates a hash for the message. In some examples, a hash for the same message can be made different for each of E₂, through Eₙ using a methodology described below.

FIG. 2 depicts a data flow and steps for a first example method 200 according to these disclosures. Method 200 operates on a binary message M (can be a binary representation of arbitrary data, such as compiled code, source code, text, video, audio, and so on) to produce a hash value g. In step 205, the message M is accessed and parsed bit by bit.

For each bit of M, one of two 2×2 matrices, A and B, is substituted (step of mapping 210) for that bit. For example, step 210 may comprise substituting the B matrix for each 0 bit (i.e., for each binary 0), and substituting the A matrix for each 1 bit (i.e., for each binary 1). Step 210 thus produces a sequence 255 of A and B matrices (which will be multiplied together in a later step).

The A and B matrices are chosen/formed as follows. P(x) is a polynomial that is defined over the field of polynomials having coefficients selected from F₂={0,1} (i.e., all coefficients of P(x) are either 1 or 0). P(x) is irreducible. The symbol α denotes a root of P(x). In an example, P(x)=x²⁵⁶+x¹²⁷+x²³+x¹³+1. Each element of each A and B matrix can be represented as an n-bit sized buffer for the purposes of implementing the hash.

The matrices A and B each can be selected from a set of matrices comprising matrices that each has been created to have the properties described above. The set of matrices may comprise the matrices

$$( \begin{matrix}1 & α \\ 0 & 1\end{matrix} ) , ( \begin{matrix}α & 1 \\ 0 & 0\end{matrix} ) , ( \begin{matrix}α & α + 1 \\ 1 & 1\end{matrix} ) ( \begin{matrix}α + 1 & α \\ 1 & 1\end{matrix} ) .$$

Each of A and B would be selected from the set without replacement, such that A and B are different.

Returning to FIG. 2 and method 200, sub-sequences of repeating binary 0's or binary 1's can be further mapped (step 215) into respective powers of B or A, producing the multiplicative matrix sequence 256, which comprises matrices raised to a power greater than or equal to 1. This sequence 256 is to be multiplied in order (step 220) to produce a hash value, h. The steps 210, 215, and 220 together can be considered a hash function H(M), which operates on the message M and returns the hash value, h.

In the example shown in FIG. 2, if M=100011001, the hash value his determined as H(M)=A·B³·A²·B²·A (if step 215 is performed) and as H(M)=A·B·B·B·A·A·B·B·A (without step 215). The number of bits in the hash value h depends on the degree n of the polynomial P(x). For any M, h has a total of 4n bits, arranged as a 2×2 matrix, where each element has n bits. In these disclosures,

$$n = \frac{{l}^{2}}{4} ,$$

where l has the meaning/usage described below. The degree of P(x) can be 256.

In step 225, a de-folder function F( ) is defined to input h and output a square l×l matrix, Y. Thus, by requiring

$$n = \frac{{l}^{2}}{4} ,$$

the produced h value has 4n bits, and h can be used to generate the desired l×l matrix output. F( ) is invertible. A simple F( ) can comprise parsing h into l bit segments, and arranging them into entries of the l×l matrix. F( ) can implement more complicated rearrangements of the bits of h, as desired. For example, F( ) can shuffle or otherwise transpose bits of h into an order different from an implied order of the bits in h. In an implementation n can be 256, so that l=8.

As will be made evident below, F( ) also can be selected to have the property of associativity, such that F(h₁*h₂)=F(h₁)F(h₂), where h₁ is a first hash from a first message (or message portion), M₁, and h₂ is a second hash from a second message (or message portion), M₂. F( ) can be selected to avoid either compressing or expanding the inputted bits. Alternatively, some implementations may benefit from expanding or compressing the inputted bits.

Returning now to FIG. 2 and method 200, the matrix Y outputted from step 225 is premultiplied (step 230) by an l×l matrix P and postmultiplied (step 230) by an l×l matrix Q⁻¹. G is defined based on this pre and post multiplication as G(M)=PF(H(M))Q⁻¹. For message M, where h=H(M), G(H(M) produces a final hash g.

Both P and Q are to be invertible and their values randomly chosen from F₂.

Returning to FIG. 1, if E₁ wishes to transmit the message M, to E₂, and to provide a hash value for it, E₁ can compute g=G(M)=PF(H(M))Q⁻¹ according to the steps of method 200, and transmit g as the hash for M. The usage of a unique pair of P and Q for each pair of communicating entities provides that only the entities of that pair can compute valid hash data for that pair of P and Q.

E₂ receives data intended to comprise the message (the data received identified as M_{E2}, allowing that it may be different from M). E₂ can verify that the message was received properly, including that it was not corrupted or intentionally altered during transmission by separately hashing g_{E2}=G(ME₂)=PF(H(ME₂))Q⁻¹ and checking whether g_{E2}=g. If they match, then it can be decided that M=M_{E2}. In this usage model, E₁ and E₂ would pre-share the P and Q used (their inverses also can be pre-shared or calculated, given P and Q). A further example is that E₂ could compute H (M) from g, (because P and Q are invertible), separately compute H(ME₂), and determine whether H(M) and H(M_{E2}) match.

### Aggregates

The disclosed hash function can be used in a variety of situations where it is desirable to provide hash aggregates.

In a first example, E₁ desires to produce hashes for two messages, M₁ and M₂, and provide the hashes to E₂ with the messages. E₁ can separately compute g₁=PF(H(M₁))Q⁻¹ and g₂=PF(H(M₂))Q⁻¹ according to method 200, above.

E₁ can transmit both M₁ and M₂, and both g₁ and g₂ to E₂. The data received at E₂ is identified respectively as M_{1-E2}, M_{2-E2}, g_{1-E2} and g_{2-E2}, allowing that any of the data transmitted could have been tampered with or corrupted. M₁ and g₁ may be calculated and/or transmitted at a different time than M₂ and g₂. In some cases, h₁ or Y₁=F(h₁) can be calculated prior to determining that E₂ is to receive M₁. After it is determined that E₂ is to receive message M₁, the P and Q pre-shared between E₁ and E₂ may be accessed, and g₁ may be created.

E₂ may need to be able to verify M_{1-E2} when it is received, M_{2-E2} when it is received, as well as verifying the concatenation of M₁ and M₂ when both have been received. It also would be desired to use the computations performed to verify M₁ to verify the hash for the entirety of M_{1-E2} and M_{2-E2}.

In verifying M_{1-E2} with g_{1-E2}, E₂ can compute F(h_{1-E2}) (i.e., performing hash H( ) on received M_{1-E2}), perform the pre and postmultiplication respectively with P and Q⁻¹ (i.e., computing PF(H(M_{1-E2}))Q⁻¹), and compare g_{1-E2} with the computed PF(H(M_{1-E2}))Q⁻¹.

To verify the concatenation of M_{1-E2} and M_{2-E2}, E₂ can compute F(h_{2-E2}) (i.e., performing hash H( ) on received M_{2-E2}). E₂ also computes g₁QP⁻¹g₂ and determines whether it equals PF(h₁)F(h₂)Q⁻¹ (where F(h_{1-E2}) already was computed). Thus, E₂ avoids repeating computations required to produce h₁.

Of course, in some implementations, a message may be segmented into many sub-parts, or a message may be streamed over a period of time, such that practical implementations would compute a large number of hashes over the course of a large data transfer, such as a video. Especially for computation constrained or power consumption constrained devices, avoidance of unnecessary computation is valuable, as it can allow using less powerful and often cheaper parts, provide longer battery life, and so on.

Another usage involves verifying an origin of an aggregation of message components, an example of which is presented below. In such a usage, E₁ computes g₃=PF(h₁)F(h₂)F(h₁*h₂)Q⁻¹. In this usage, the operator * can provide for the output of F(h₁*h₂) to be a 2×2 matrix, each element of such having n bits. As such, h₁*h₂ can be implemented as a matrix multiplication, for example. In another example, h₁*h₂ can be implemented as a concatenation, h₁∥h₂, and F( ) also can compress the bits of the concatenation to 4n bits while performing the function of producing the matrix Y.

E₁ also computes g₄=PF(h₁∥h₂)Q⁻¹. E₁ sends g₁, g₂, g₃, and g₄ to E₂. E₂ determines whether g_{3-E2}=g_{1-E2}Q⁻¹Pg_{2-E2}Q⁻¹Pg_{4-E2} (all subscripts identifying “as received” values) to verify the source of the aggregation.

### Other Variations

It was introduced with respect to FIG. 2 above that there is a substitution of the matrices A and B respectively for binary 1 and binary 0 (or vice versa, since A and B are interchangeable and the designation is therefore for convenience) in a message M, then sequences of A and B matrices were replaced with powers of those matrices. Such powers can be pre-computed to speed up the multiplication in step 220 of method 200. The steps of mapping the binary values to the matrices (step 210) and replacing with powers (step 215) were separately shown to better explain the example method. In implementations, there can be a direct substitution between strings of binary 1's or binary 0's with appropriate powers of the A and B matrices.

In a further implementation, a number of pre-computed multiplicative combinations of the A and B matrices can be provided. For example, W={A, A², AB, B², A²B, B²A, B²A² . . . A^{c}B^{d}} can be provided, where c and d can be any integers greater than or equal to 1, and each element in W is a 2×2 matrix. Having a wider variety of potential mappings between pre-multiplied combinations of the A and B matrices can increase speed and efficiency. For example, when parsing a message in order, there can be a number of substitutions of elements from W that are valid, and among these valid selections, a choice can be made. The choice can be made to increase speed. In some implementations, the choice can be made to provide random or pseudorandom selections of these pre-computed matrices.

### COMPREHENSIVE METHOD EXAMPLE

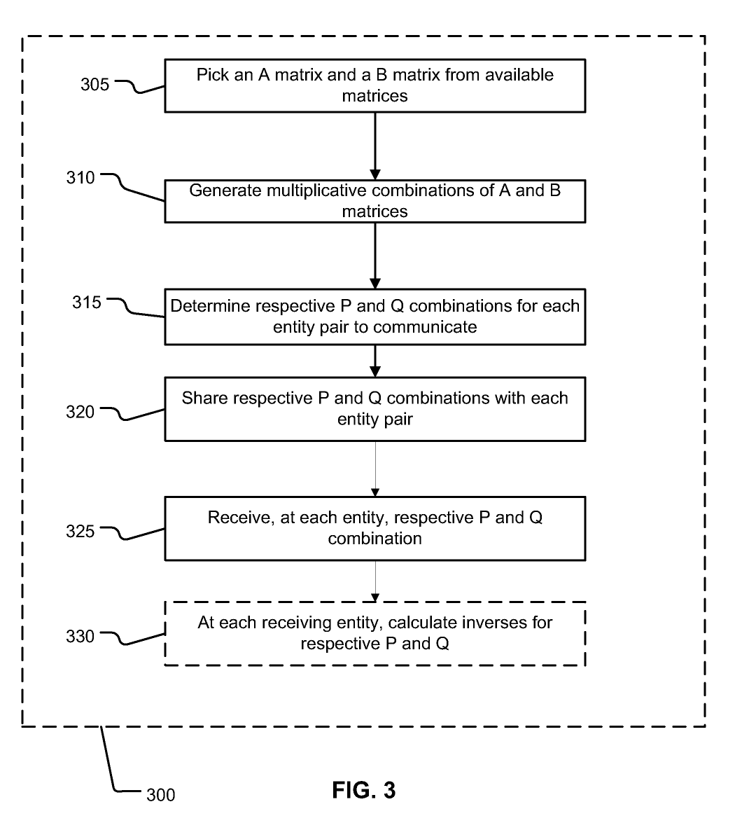

FIG. 3 illustrates an initialization method 300, which can be implemented partially at E₁, and at partially at entities to be communicating with E₁ (example of E₁ communicating with any of E₂ through Eₙ is specific example of an any-to-any communication scheme among any of E₁ through Eₙ).

Method 300 includes picking (step 305) an A matrix and a B matrix from an available set of matrices. A set of multiplicative combinations of the selected A and B matrices (e.g., W) is produced (step 310).

Method 300 includes determining (step 315) respective P and Q combinations for each entity of E₂ through Eₙ to be communicating with E₁. In other words, a distinct P and Q pair is generated for communication between E₁ and E₂ and so on. Optionally, inverses for each P and Q generated can also be determined in step 310. Step 320 comprises sharing these P and Q combinations, and optionally their calculated inverses, with respective entities. Step 325 comprises receiving, at each respective entity, its P and Q combination. If inverses for P and Q were not transmitted, then each entity can calculate (step 330) those inverses.

A method 400 can be performed each time a message M is to be sent from one entity to another (e.g., from E₁ to E₂). Method 400 comprises receiving (step 415) or otherwise accessing the message M. Method 400 also includes segmenting (step 420) M into a plurality of blocks m₁-m_{b}. These blocks are distributed (step 425) among a plurality of processing resources (e.g., selections of one or more of different FPGAs, processing cores, threads, servers, and the like). Each such processing resource also has access to the selected matrices A and B, or receives those as well. Each block m₁-m_{b} is parsed as a sequence of bits into respective multiplicative sequences of matrices (that can be selected from the matrices calculated in step 310 of method 300, above).

A method for selecting each matrix to substitute for one or more bits of each message block m₁-m_{b} may comprise maintaining a pointer to a current position in the string of bits comprising a given block being processed, and identifying several potential matrices that can be next selected. Each potential selection may represent a differing number of bits; for example A² represents 2 bits, while A⁴ represents 4 bits, even though both are still 2×2 matrices. Then, a selection of one of these potential matrices is made, and that selection is added to the matrix sequence. The pointer is moved an appropriate number of bits, and the process is repeated. In some cases, the matrix can be selected based on which matrix represents a largest number of bits, e.g., BA² would be selected preferentially to BA if the bitstring at the current pointer location included “011 . . . .”

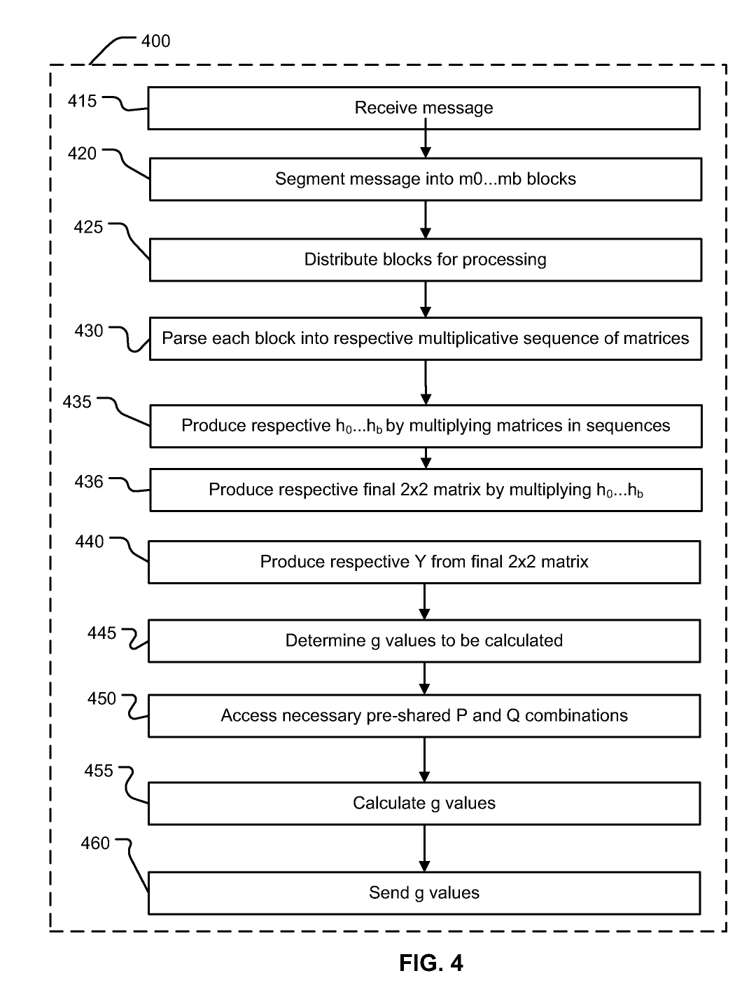

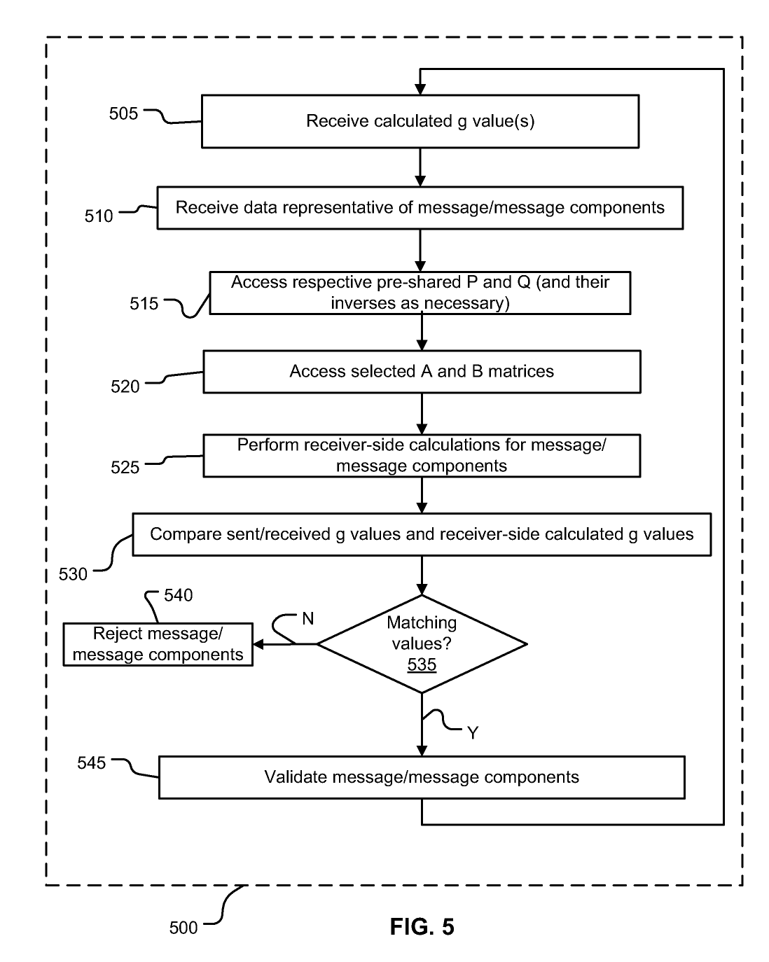

Returning now to FIG. 4, method 400 continues (concurrently in the processing resources) with producing (step 435) respective h₁ . . . h_{b} values for each of blocks m₁-m_{b}. The h₁ . . . h_{b} are multiplied together (step 436) to produce a final 2×2 h matrix. Then, the final h matrix is operated on by F( ), to produce Y.

Method 400 then comprises determining (step 445) which g values are to be calculated in this instance of method 400. For example, all of E₂ through Eₙ (FIG. 1) may need to receive M. Each of entity E₂ through Eₙ may be assigned a different respective P and Q matrix pair, each being preshared between E₁ and respectively one of E₂ through Eₙ. So, a respective g value may be calculated for each of E₂ through Eₙ.

Also, where it is desired to stream portions of the message, it may be desired to compute several intermediate g values for portions of M. For example, a g may be calculated for blocks on 1024 block intervals, e.g., a g can be calculated for m₁ . . . m₁₀₂₄ for each of entities E₂ through Eₙ. In producing the g value for m₁ . . . m₁₀₂₄, there can be an h value calculated concurrently for each of m₁ . . . m₁₀₂₄ in different computing resources, and these h values can be used in arriving at g₁₋₁₀₂₄=PF(h₁h₂ . . . h₁₀₂₄)Q⁻¹.

Also, it may be desired to provide hash origin verifiability, and so respective g₃ and g₄ hashes also can be calculated for each of E₂ through Eₙ. Thus, method 400 illustrates the broad usage of the hash function aspects disclosed above, including using respective unique P and Q pairs between each pair of communicating entities, allowing hash aggregation, parallelization of computation, and origin verification.

Similarly, step 450 comprises accessing the P and Q combinations (pre-shared between E₁ and one of E₂ through Eₙ), and which are to be used in producing the g values that were determined in step 445. Step 455 comprises calculating the g values, and step 360 comprises sending the g values to their respective entities. The send step 460 also may comprise identifying the g values, where multiple g values are included, so that they may be distinguished from each other. Such identification may be implicit in an ordering of a transmission. Also, an entity generating the hash values may provide information about what matrices were used to produce the hash values; for example, information to select the matrices from a known set of matrices can be provided.

Method 500 illustrates exemplary steps that can be performed by each of E₂ through Eₙ when receiving message(s) and hash value(s) to be verified from E₁, and which may have been formed according to the steps of method 400, above.

Method 500 comprises receiving one or more calculated g values, and as necessary, determining what the g values represent (e.g., a hash value for a single block, for a concatenation of blocks, for verifying origin, and so on). Method 500 further comprises receiving (step 510) data representative of a message or blocks (when aggregating) of a message. Step 515 comprises accessing the P and Q for the entity performing method 500. Method 500 also comprises accessing (step 520) the selected A and B matrices that were used in producing the g value(s) provided. Such matrices can be the same for all g values or can vary.

Method 500 also comprises performing (step 525) calculations for verifying the message or message blocks for which g values were provided. These calculations can vary depending on which g values were provided, and for which blocks. For example, if a single message hash value g is to be verified, then method 500 may comprise determining a corresponding g for the message as received and comparing (step 530) them. Other calculations that can be performed are described above, and include calculations relating to hash aggregates, and origin verification.

If values calculated (step 525) can be successfully compared (step 530), then a positive determination (step 535) that the received message accurately represents the transmitted message can be made. Responsive to that determination (step 535), the message and/or components thereof can be validated (step 545). If there is a failure to obtain a successful comparison in step 530, then the message or message components can be rejected as potentially invalid (step 540).

Method 500 can also comprise looping to step 505 where more g values can be received, which can relate to further received data (step 510). The looping thus illustrates that the reception of data to be validated can occur over a period of time, as would often be the case when using hash aggregation.

The exemplary ordering of steps in any flow chart depicted does not imply that steps necessarily be completed in that order. Any of intermediate values, or final values, or other data described as being generated or produced can be saved to a computer readable medium, either temporarily, such as in a RAM, or more permanently, such as in non-volatile storage.

FIG. 6 illustrates a computer system 600, in communication with a second computer system 675. Computer system 600 is an example of computer hardware, software, and firmware that can be used to implement disclosures below. System 600 includes a processor 620, representative of any number of physically and/or logically distinct resources capable of executing software, firmware, and hardware configured to perform identified computations. Processor 620 communicates with a chipset 622 that can control input to and output from processor 620. In this example, chipset 622 outputs information to display 640, and can read and write information to non-volatile storage 660, which can include magnetic media, and solid state media, for example. Chipset 622 also can read data from and write data to RAM 670. A bridge 635 for interfacing with a variety of user interface components can be provided for interfacing with chipset 622. Such user interface components can include a keyboard 636, a microphone 637, touch detection and processing circuitry 638, a pointing device, such as a mouse 639, and so on. In general, inputs to system 600 can come from any of a variety of sources, machine generated and/or human generated.

Chipset 622 also can interface with one or more data network interfaces 625, that can have different physical interfaces 617. Such data network interfaces can include interfaces for wired and wireless local area networks, for broadband wireless networks, as well as personal area networks. Some applications of the hashing disclosures herein can include receiving data from system 675 through physical interface 617 through data network 625, and in preparation to store the data in non-volatile storage 660, system 600 can calculate a hash value for the data, and use that hash value as an identifier for a file containing the received data. Further examples relating to file naming can include generating data through processing performed on processor 620, and which is to be stored in RAM 670 and/or non-volatile storage 660.

Methods according to the above-described examples can be implemented using computer-executable instructions that are stored or otherwise available from computer readable media. Such instructions comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality also can be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

We claim:

1. A method for hashing a message, comprising:
accessing a first 2 by 2 matrix A and a second 2 by 2 matrix B, wherein A and B are each selected from the Special Linear group SL₂(R), R being a commutative field defined as R=F₂[x]/(P), F₂[x] being the set of polynomials having coefficients selected from the set of F₂={0,1}, and (P) being the ideal of F₂[x] generated by an irreducible polynomial P(x) of order n=1²/4;
accessing a message M₁ as a sequence of bits;
producing a multiplicative matrix sequence by substituting the B matrix for every binary 0 in M₁ and substituting the A matrix for every binary 1 in M₁;
computing the product of the matrices in the sequence to produce a 2 by 2 matrix (h₁), each element of h₁ having n bits;
rearranging the bits of h₁ into an l by l matrix Y₁;
computing g=PY₁Q⁻¹, wherein P and Q are each invertible l by l matrices with elements randomly or pseudorandomly chosen from F₂; and
outputting g as a hash for the message M₁.

2. The method of claim 1, wherein the hash g is outputted to an entity E₂ with which P and Q has been preshared.

3. The method of claim 1, further comprising:
producing a second matrix sequence for a message M₂ to be concatenated with M₁;
computing the product of the matrices in the second matrix sequence to produce a 2 by 2 matrix (h₂), each element of h₂ having n bits;
multiplying h₁ and h₂ to produce a 2 by 2 matrix h₁₂, each element of h₁₂ having n bits;
rearranging the bits of h₁₂ into an l by l matrix Y₁₂;
computing g′=PY₁₂Q⁻¹ as a hash for the concatenation of messages M₁ and M₂.

4. The method of claim 3, further comprising obtaining the messages M₁ and M₂ by subdividing a precursor message.

5. The method of claim 1, further comprising recovering h from g=PY₁Q⁻¹ by using an inverse of F, an inverse of P, and Q;

6. The method of claim 1, wherein h₁ and h₂ are computed with distinct processing resources.

7. The method of claim 1, further comprising selecting each of A and B as invertible and independent 2×2 matrices.

8. The method of claim 7, further comprising selecting A and B, without replacement from a set of matrices comprising the matrices
$$( \begin{matrix}1 & α \\ 0 & 1\end{matrix} ) , ( \begin{matrix}α & 1 \\ 1 & 0\end{matrix} ) , ( \begin{matrix}α & α + 1 \\ 1 & 1\end{matrix} ) ( \begin{matrix}α + 1 & α \\ 1 & 1\end{matrix} ) ,$$
wherein a is a root of P(x).

9. The method of claim 1, wherein the producing of the multiplicative matrix sequence is effected respectively by substituting powers of the A matrix for a series of binary 1's and by substituting powers of the B matrix for a series of binary 0's.

10. The method of claim 1, wherein the producing of the multiplicative matrix sequence is effected by selecting multiplicative combinations of the A matrix and the B matrix for substitution of matching portions of the sequence of bits.

11. The method of claim 10, further comprising computing a set of the multiplicative combinations of the A matrix and the B matrix and storing the set, from which the selecting can be performed.

12. The method of claim 11, wherein the set of multiplicative combinations comprises W={A, A², AB, B², A²B, B²A, B²A² . . . A^{c}B^{d}}, wherein c and d are integers greater than or equal to 1.

13. The method of claim 12, wherein the selecting can be performed from a subset of the set of multiplicative combinations, the elements of the subset determined to match with one or more bits of the sequence of bits, starting from a current point in M₁.

14. The method of claim 13, wherein the selecting from the subset is directed to increase processing speed.

15. The method of claim 14, wherein the selecting from the subset is according to an identification of a largest number of bits that can be substituted for a member of the set W.

16. The method of claim 13, wherein the selecting is done randomly or pseudorandomly from the subset.

17. The method of claim 1, further comprising
sending data representative of M₁, from an entity E₁, to an entity E₂, and at E₂, receiving the data, and calculating a g_{E2}, using the data received, by
producing a multiplicative matrix sequence by substituting the B matrix for every binary 0 in the received data and substituting the A matrix for every binary 1 in the received data;
computing the product of the matrices in the sequence to produce a 2 by 2 matrix (h_{E2}), each element of h_{E2} having n bits;
rearranging the bits of h_{E2} into an l by l matrix Y_{E2};
computing g_{E2}=PY_{E2}Q⁻¹; and
comparing g with g_{E2} to determine whether the received data correctly describes M₁.

18. The method of claim 17, further comprising pre-sharing P and Q between E₁ and E₂.

19. A parallelizable hash function method, comprising:
accessing a first 2 by 2 matrix A and a second 2 by 2 matrix B, wherein A and B are each selected from the Special Linear group SL₂(R), R being a commutative field defined as R=F₂[x]/(P), F₂[x] being the set of polynomials having coefficients selected from the set of F₂={0,1}, and (P) being the ideal of F₂[x] generated by an irreducible polynomial P(x) of order n=1²/4;
subdividing a message M into components m₁-mₜ;
producing a respective multiplicative matrix sequence for each component m₁-mₜ by substituting the B matrix for every binary 0 in each component and substituting the A matrix for every binary 1 in each component;
computing respective products of the matrices in each sequence to produce a respective 2 by 2 matrix (h₁-hₜ), each element of each matrix having n bits;
computing a product of h₁-hₜ, resulting in a final 2 by 2 matrix;
rearranging the bits of the final 2 by 2 matrix into an l by l matrix Y; and
computing g=PYQ⁻¹ as a hash value for the message M, wherein elements of P and Q are selected from F₂ randomly or pseudorandomly.

20. The method of claim 19, wherein the computing of the respective products of the matrices in each sequence is performed in a respective distinct computing resource selected from a thread of computation, a computation core, a general purpose processor, and an application specific circuit.

21. The method of claim 19, wherein the producing of each multiplicative matrix sequence is effected respectively by substituting powers of the A matrix for a series of binary 1's and by substituting powers of the B matrix for a series of binary 0's.

22. The method of claim 19, wherein the producing of each multiplicative matrix sequence is effected by selecting multiplicative combinations of the A matrix and the B matrix for substitution of matching portions of the sequence of bits.

23. The method of claim 22, wherein the selecting of the multiplicative combinations is effected by randomly or pseudorandomly selecting each combination from a group of candidate combinations determined to match one or more bits beginning from a pointer marking a current position in processing of M.

24. The method of claim 19, further comprising storing matrices h₁ . . . hₜ, determining an entity Eₙ to receive message components mₛ₁-mₛ₂, s1≦s2≦t; computing a product of hₛ₁ . . . hₛ₂ to produce a 2 by 2 matrix Yₛ₁₋ₛ₂, accessing a Pₙ and Qₙ matrix combination associated with Eₙ, computing gₛ₁₋ₛ₂=PₙYₛ₁₋ₛ₂Qₙ⁻¹ as a hash value for message components mₛ₁-mₛ₂ and specific for Eₙ.

25. The method of claim 24, wherein s1 and s2 are repeatedly and respectively incremented until s2=t to produce respective g values for each interval, transmitting the message components for each interval, and the respective g value calculated therefore to Eₙ over a period of time.

26. A computer readable medium storing computer readable data for producing a hash of a message, the data interpretable to comprise:
a first 2 by 2 matrix A and a second 2 by 2 matrix B, wherein A and B are each selected from the Special Linear group SL₂(R), R being a commutative field defined as R=F₂[x]/(P), F₂[x] having coefficients selected from the set of F₂={0,1}, and (P) being the ideal of F₂[x] generated by an irreducible polynomial P(x) of order n=1²/4;
instructions for accessing a message M composed of bits;
instructions for producing a matrix sequence by substituting the B matrix for every binary 0 in M and substituting the A matrix for every binary 1 in M;
instructions for computing the product of the matrices in the sequence to produce a 2 by 2 matrix (h), each element of h having n bits;
instructions for implementing a function F to rearrange the bits of h into an l by l matrix Y;
instructions for computing g=PYQ⁻¹, wherein P and Q are each invertible l by l matrices with elements randomly or pseudorandomly chosen from F₂; and
instructions for accessing a hash value g₂, and comparing g₂ with g to determine whether the message M was accessed correctly.

27. The computer readable medium of claim 26, wherein the matrices A and B are selected without replacement from the matrices
$$( \begin{matrix}1 & α \\ 0 & 1\end{matrix} ) , ( \begin{matrix}α & 1 \\ 1 & 0\end{matrix} ) , ( \begin{matrix}α & α + 1 \\ 1 & 1\end{matrix} )$$
and
$$( \begin{matrix}α + 1 & α \\ 1 & 1\end{matrix} ) ,$$
wherein α is a root of P(x).

28. The computer readable medium of claim 26, further comprising instructions for subdividing M into segments m₁ through mₙ, and wherein the matrix sequence instructions are concurrently executable to produce respective matrix sequences for each m₁ through mₙ, the matrix sequence product instructions are concurrently executable to produce respective h₁ through hₙ products, and the function F instructions are operable on a product of h₁ through hₙ to produce the matrix Y.
